(19) United States
(12) Patent Application Publication
(10) Pub. No.: US 2009/0180201 A1
(43) Pub. Date: Jul. 16, 2009

(54) MAGNIFIED AND ILLUMINATED WRITING INSTRUMENT

(75) Inventor: Mitch Junkins, Newport Beach, CA (US)

Correspondence Address: Rutan & Tucker, LLP., 611 ANTON BLVD, SUITE 1400, COSTA MESA, CA, 92626, US

(73) Assignee: The CDM Company, Inc., Newport Beach, CA (US)

(21) Appl. No.: 11/944,867

(22) Filed: Nov. 26, 2007

Related U.S. Application Data
(60) Provisional application No. 60/867,235, filed on Nov. 27, 2006.

(51) Int. Cl. G02B 25/02

(52) U.S. Cl. 359/803; 359/802; 359/810

(57) ABSTRACT

A writing instrument with a plurality of usable portions thereon is provided. The writing instrument utilizes a standard writing instrument but incorporates a magnifying portion to the writing instrument. Additionally, the writing instrument also incorporates a magnifying portion in a central location on the writing instrument and also a lighting instrument on a portion of the writing instrument to illuminate the intended document to be examined. The invention may comprise a plurality of parts including the magnifying portion, the writing portion and the lighting portion wherein these portions may be located on different areas of the writing instrument.

The present invention claims priority to the earlier filed U.S. Provisional application having a Ser. No. 60/867,235 and filed on Nov. 27, 2006.

### FIELD OF THE INVENTION

The field of the invention is for writing instruments. More specifically, the field of invention is for a writing pen having a magnifier and writing portion thereon.

### BACKGROUND

There are a great many different types of pens, pencils, felt tip markers, and other writing instruments in today's market. These writing instruments are used for a variety of different purposes including educational uses, commercial usages and a host of others. In addition to the writing instrument, writing functions, many such devices also operate as artistic expressions, educational elements, advertisements for products and even as toys. There are many writing instruments that have attachments or other elements that are affixed to the end of writing instrument for fanciful purposes or otherwise. Additionally, erasers and other helpful portions may also be affixed to the writing instrument to help in the writing process.

It is well know to add certain helpful elements to a writing instrument to help an individual identify the writing. For example, there are writing instruments that have large type printing techniques such that the writing is more visible to the user and any subsequent viewer of the writing. Additionally, there are other elements that may be fastened to the writing instrument to help either the user or the subsequent viewer of the writing.

However, a problem that exists is for those individuals with very poor eye sight. Typically, this individual needs some type of separate magnifying structure to determine if the writing is appropriate or whether they need to make changes. Additionally, the problem is that the user will typically need multiple elements including a pen, and magnifying glass to see the writing they wish to alter and/or view.

Another problem that exists that even with the magnifying structure, there may be insufficient lighting such that another element may need to be introduced in order to properly view/alter and/or make changes to any writing.

Therefore a need exists for an improved writing device having a plurality of structures including a magnifying portion, a lighting portion and a writing portion.

### SUMMARY OF THE INVENTION

The present invention provides a writing instrument with a plurality of usable portions thereon. The contemplated embodiments of the writing instrument utilizes a standard writing instrument but incorporates a magnifying portion to the writing instrument. Additionally, the contemplated embodiment also incorporates a magnifying portion in a central location on the writing instrument and also a lighting instrument on a portion of the writing instrument to illuminate the intended document to be examined. The invention may comprise a plurality of parts including the magnifying portion, the writing portion and the lighting portion wherein these portions may be located on different areas of the writing instrument.

To this end, in an exemplary embodiment of the present invention, an apparatus for use in marking of an object is provided. The apparatus has a structure to accommodate a writing portion and a magnifying portion incorporated into the structure. Additionally, the apparatus has an illumination portion incorporated into the structure and a power source in conjunction with the illumination portion whereby the power source provides power to initiate lighting.

In an exemplary embodiment, the apparatus has a power source that may be a battery.

In an exemplary embodiment, the apparatus has a magnifying portion that may be incorporated into the structure of the apparatus at the top portion thereof.

In an exemplary embodiment, the apparatus has a magnifying portion that may be incorporated into the structure of the apparatus at the opposing end of the writing portion of the apparatus.

In an exemplary embodiment, the apparatus has an illumination portion that may be comprised of a LED bulb.

In an exemplary embodiment, the apparatus has an illumination portion that may be comprised of a plurality of lighting sources wherein the lighting source is an LED bulb.

In an exemplary embodiment, the apparatus has an illumination portion having at least one light source directed away from the apparatus and at least one light source directed into the magnifier lens of the apparatus.

In an exemplary embodiment, the apparatus has a magnifier lens cover incorporated into an interior cavity of the apparatus.

In an exemplary embodiment, the apparatus has a rotation knob on a top portion of the apparatus whereby the rotation knob is utilized to close a cover over a magnifier lens.

In an exemplary embodiment, the apparatus has a clip extending away from the apparatus for attachment to an object.

To this end, in an exemplary embodiment of the present invention, a method for utilizing a writing instrument with a magnifier lens is provided. The method comprises the steps of: providing a structure to accommodate a writing portion; providing a magnifying portion incorporated into the structure; and providing an illumination source.

In an exemplary embodiment, the method further comprises the step of: providing a plurality of illumination sources.

In an exemplary embodiment, the method further comprises the step of: providing a cover portion whereby the cover portion may be rotated to cover the magnifying portion and the illumination source.

In an exemplary embodiment, the method further comprises the step of: accessing a cover portion by utilizing a rotation knob contained on the top portion of the writing instrument.

In an exemplary embodiment, the method further comprises the step of: allowing an individual to utilize the writing instrument to mark an object.

In an exemplary embodiment, the method further comprises the step of: allowing an individual to utilize the writing instrument to mark an object whereby the lighting source may be turned on to illuminate the object prior to the individual making the marking.

In an exemplary embodiment, the method further comprises the step of: providing a cap portion to access the interior portion of the writing instrument to access an insert whereby the insert is an ink cartridge.

In an exemplary embodiment, the method further comprises the step of: providing a cover portion whereby the cover portion is rotatably move into a position over the magnifying portion and the lighting source whereby the user may rotatably open and close the cover portion relative to the magnifying portion and the lighting source.

In an exemplary embodiment, the apparatus has an apparatus structure that may comprise: a pen, pencil, marker, crayon, highlighter, and the like.

In an exemplary embodiment, the apparatus has an illumination portion and a magnifying portion that are removably attached to the structure of the apparatus for removal and attachment thereto.

Among the many different possibilities contemplated, the writing apparatus may allow for multiple uses of the same instrument for different purposes.

Additionally, in an exemplary embodiment, the writing apparatus may be used strictly for writing.

In yet another exemplary embodiment, it is contemplated that the writing apparatus may be a pen.

Still another exemplary embodiment, it is contemplated that the writing apparatus may be a pencil.

Yet another exemplary embodiment, it is contemplated that the writing apparatus may be any other type of writing instrument of marking such as marker, crayon, felt tip, and the like.

In another exemplary embodiment, it is contemplated that the writing apparatus may be utilized as a conventional pen wherein the lighting apparatus incorporated thereon may allow for better visibility of the markings made by the pen.

Still a further exemplary embodiment is to provide a writing apparatus which may have a magnifier portion and a lighting source.

In yet another exemplary embodiment, it is contemplated that a writing apparatus having a magnifier portion and a lighting source be a pen.

Yet another exemplary embodiment of the present invention is to provide a writing apparatus whereby the writing apparatus may be a pen, pencil, marker, highlighter, eraser, or any other contemplated writing device.

In another exemplary embodiment of the present invention, a writing apparatus is provided whereby the writing apparatus may have at least one magnifier portion and in an embodiment may have a plurality of magnifier portions.

Still another exemplary embodiment of the present invention is to provide a writing apparatus with a magnifier portion and at least one lighting source.

Another exemplary embodiment of the present invention is to provide a writing apparatus with a magnifier portion and a plurality of lighting sources.

In yet another exemplary embodiment, it is contemplated that a writing instrument having a magnifier lens is provided whereby the magnifier lens is integrated into the design of the writing instrument.

Still another exemplary embodiment of the present invention is to provide a writing apparatus with a magnifier lens and a lighting source, whereby the lighting source is integrated into the design of the writing instrument.

Yet another exemplary embodiment of the present invention is to provide a writing instrument with a plurality of lighting sources whereby at least one lighting source is utilized to illuminate the magnifier lens.

In yet another exemplary embodiment of the present invention, a writing instrument is provided whereby the writing instrument may have a plurality of lighting sources whereby at least one lighting source is utilized to illuminate a marked object, device or paper.

A further exemplary embodiment contemplates that the writing apparatus may have a plurality of lighting sources thereon whereby the lighting source may point at a future point on the marked paper or object whereby the individual using the pen would be able to see ahead of the location that they desire to write.

In yet another exemplary embodiment of the present invention, a writing instrument is provided whereby the writing instrument has a plurality of lighting sources whereby at least one lighting source projects away from the writing instrument to illuminate the object to be marked by the writing instrument.

Further, a contemplated embodiment of the writing instrument may be to allow a user to utilize the writing instrument at any time during the day including during night time and/or evening hours where light sources are in short supply.

Additionally, in an exemplary embodiment, the writing instrument may allow for multiple functions including magnification of existing writing.

In still another exemplary embodiment, the writing instrument may allow for multiple functions including magnification of concurrently drafted information.

Another exemplary embodiment, is to provide a writing instrument wherein the writing instrument has a magnifying portion thereon wherein the magnifying portion may be at a mid-point of the writing instrument.

Still another exemplary embodiment of the present invention is to provide a writing instrument wherein the writing instrument has a magnifying portion thereon wherein the magnifying portion may be at a location on a first end of the writing instrument and/or on a second end of the writing instrument including at a location distant to the writing portion.

A further exemplary embodiment of the present invention may include an illumination source, a magnifying portion and a writing portion all integrated into a singular writing instrument.

In yet another exemplary embodiment of the present invention, a writing instrument is provided whereby the writing instrument may have a plurality of magnifying portions whereby the user may utilize the magnifying portions as a mock eye glass.

Still another exemplary embodiment of the present invention is to provide a writing instrument wherein the writing instrument has a magnifying portion thereon wherein the magnifying portion may be hidden from sight by a cover portion wherein when the writing instrument is twisted and/or a button activated, the cover portion may recess thereby allowing for the use of the magnifying portion.

A further exemplary embodiment of the present invention may include a writing instrument whereby the instrument may have a plurality of magnifying portions whereby different magnifying portions may be activated for different uses including the use of the magnifying portion close to the desired object, and the use of a magnifying portion whereby the user may instead hold the magnifier to their eyes to magnify an object.

Yet another exemplary embodiment of the present invention may include a writing instrument whereby the instrument may have a singular magnifying portion separated by a nose portion whereby the user may utilize the writing instrument as eyeglasses.

Still another exemplary embodiment of the present invention is to provide a writing instrument wherein the writing instrument may have a notch thereon to accommodate the nose of the individual such that the writing instrument may be utilized as a pen, and as eyeglasses.

Another exemplary embodiment may include a writing instrument wherein the writing instrument may be utilized to magnify, illuminate and/or mark an object singularly, or in combination to another element of the writing instrument.

Still another exemplary embodiment of the present invention is to provide a writing instrument with an illumination source wherein the illumination source may be powered by a power source such as a small battery and the like.

Yet another exemplary embodiment of the present invention is to provide a writing instrument wherein the writing instrument may be constructed of plastic.

Another exemplary embodiment of the present invention is to provide a writing instrument wherein the writing instrument may be constructed of any suitable material such as polyurethane, metals, wood, plastics, cardboard, wax and the like.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWING

FIG. 1 is a perspective view of the writing instrument in an exemplary embodiment of the present invention.

FIG. 2 is a cross sectional perspective view of the top portion of the writing instrument in an exemplary embodiment of the present invention.

FIG. 3 is a perspective view of the top portion of the writing instrument illustrating the cover portion in the closed position in an exemplary embodiment of the present invention.

FIG. 4 is a perspective view of the bottom portion of the writing instrument in an exemplary embodiment of the present invention.

### DETAILED DESCRIPTION OF THE PREFERRED EMBODIMENT

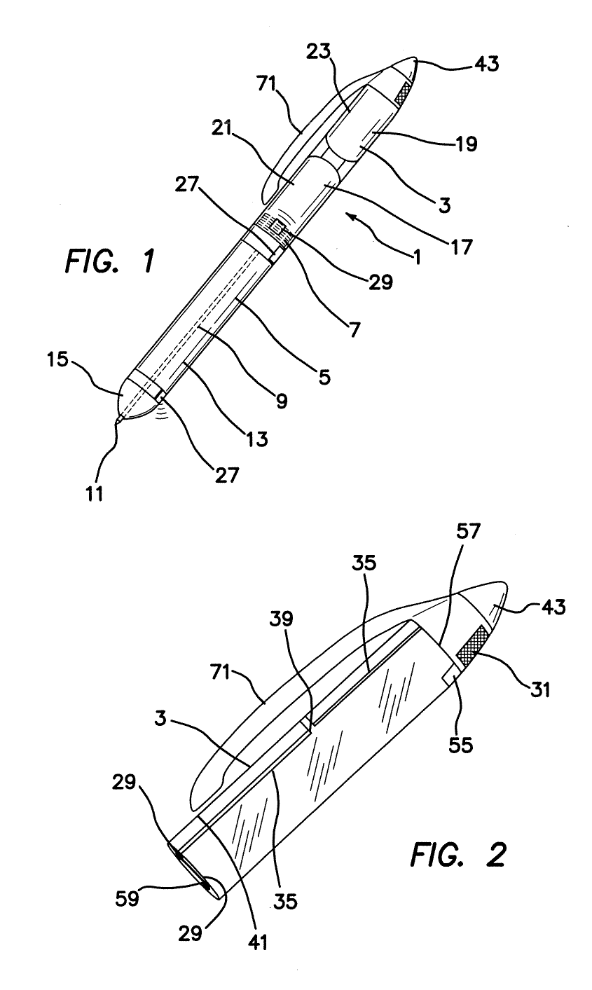

Referring now to the drawings where like numbers are used to describe exemplary embodiments of the present invention, an illuminated writing instrument is illustrated herein. As illustrated in FIG. 1, the illuminated writing instrument 1 may take the form of a pen. However, it should be understood that a person of ordinary skill in the art could appreciate that any writing instrument may be utilized and/or embodied by the present invention. For example, it is contemplated that the writing apparatus may be a pencil, marker, crayon, eraser, highlighter, or any other type of writing instrument. For ease of explanation, the present invention utilizes the exemplary embodiment of a pen. However, it should be understood that the present invention is not limited to the specific embodiment of a pen.

As illustrated in FIG. 1, the writing instrument 1 in the form of a pen may have a plurality of sections including a top portion 3 and a bottom portion 5. The top portion 3 may be have a threaded portion 5 which connects to a corresponding threaded portion 7 on the bottom portion 5 of the writing instrument 1. In an exemplary embodiment, the writing instrument 1 may have an insert 9 which may contain the ink 11 used to make a marking on a paper (not shown). The insert 9 may be removable and replaceable from an interior portion 13 of the writing instrument 1. The insert 9 may also be removable from the interior portion 13 and replaced with another insert 9 when the ink 11 has been exhausted within the insert. The bottom portion 5 may further have a cap 15 which is threadably attached to the bottom portion 5 and may allow for access to the interior portion 13 of the writing instrument 1.

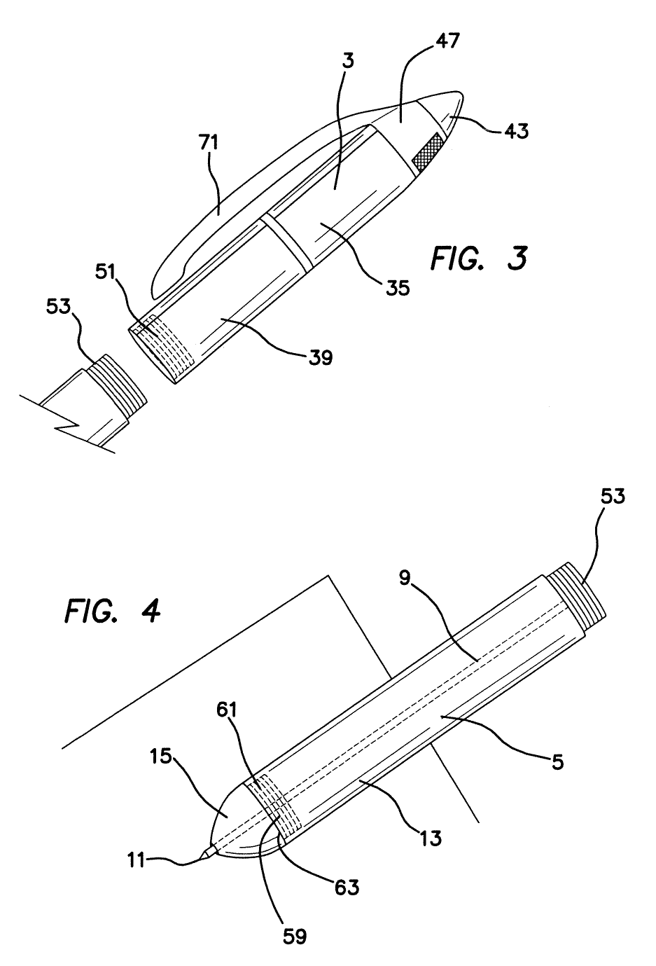

As further illustrated in FIG. 1, the top portion 3 of the writing instrument may be constructed of a suitable material whereby the material may be see through. Additionally, the see through material may be of significant refraction to allow for magnification of an object when the see through portion 17 of the writing instrument 1 is placed in close proximately to the object (as illustrated in FIG. 5). The see through portion 17 may preferably be a magnifier lens 19 which may be utilized to magnify an object or writing made by or viewed by an end user. The magnifier lens 19 may be a single unitary unit as illustrated in FIG. 3 or may have a first lens 21 and a second lens 23 which may be utilized separate by a viewers eyes. In an another exemplary embodiment, the first lens 21 and the second lens 23 may have different magnification strengths whereby the first lens 21 may have a specific strength and/or magnification quotient, whereby the second lens 23 may have another specific strength and/or magnification quotient which may be either stronger and/or weaker than the first lens 21 magnification strength thereby allowing the user multiple different magnification strengths of an object or writing to be viewed.

Additionally, as illustrated in FIGS. 1-3, the writing instrument may further have at least one lighting source 27 contained therein. The lighting source may be an LED light 28 which may illuminate the paper in which the user wishes to mark, thereby allowing for better visibility of the paper when lighting is a factor. The LED light may be contained on the bottom portion 5 of the writing instrument 1 and may point downward to illuminate the paper for which the viewer wishes to mark. However, it is contemplated that a plurality of lighting sources 27 may be embodied on the writing instrument 1 as illustrated in FIG. 2 whereby a first lighting source 27 may be utilized on the bottom portion 5 of the writing instrument 1 and a second lighting source 29 may be utilized on the top portion 3 of the writing instrument. While the first lighting source 27 may point downward to illuminate the paper in which the user wishes to mark, the second lighting source 29 may be contained within the magnifier lens 19 contained within the top portion 3 of the writing instrument 1. The second lighting source 29 may illuminate the magnifier lens 19 which when applied to the paper or and object for viewing will similarly illuminate the object/paper and thereby allow an end user to magnify and illuminate a desired object, writing, or mark at the same time, thereby eliminating the need for multiple devices for illumination and magnification.

FIG. 2 illustrates a cross sectional view of the writing instrument 1. As illustrated, FIG. 2 illustrates a cross-sectional view of the top portion 3 of the writing instrument 1 whereby the magnifier lens 19 and the second lighting source 29 are shown. In additional, a power source 31 is illustrated which may take the form of a battery to power the lighting source 29 contained in the top portion 3 of the writing instrument 1. Additionally, FIG. 2 illustrates a cover portion 35 which may be utilized by the user to close and cover the magnifier lens 19 and the second lighting source 29 when not in use. The cover portion 35 may allow the user to save and secure the magnifier lens 19 from scratches and may further deter undesirable distraction by a user when the magnifier lens 19 is not in use. The cover portion 35 may have two positions, an open position 37 and a closed position 39 whereby when the cover portion 35 is in the open position 37, the cover portion 35 is concealed in an interior cavity 41 of the top portion 3 of the writing instrument 1. When the cover portion 35 is in the closed position 39, the cover portion 35 extends out of the interior cavity 41 of the top portion and rotates into a position over the magnifier lens 19 and the second lighting source 29. The cover portion 35 may be moved from an open position 37 to a close position 39 by utilizing a rotation knob 43 contained on the top edge 47 of the top portion 3 of the writing instrument 1. FIG. 2 further illustrates a third lighting source 55 whereby the third lighting source 55 may be positioned at a first end 57 of the magnifier lens 19 whereby the second lighting source 29 may be positioned at a second end 59 of the magnifier lens 19. In this embodiment, the second lighting source 29 and the third lighting source 55 may evenly illuminate the magnifier lens 19 and may further illuminate the document, object or marking to be magnified. Additionally, it is contemplated that the second lighting source 29 may be positioned to illuminate the magnifier lens 19, while the third lighting source 55 may be utilized and configured to point outward from the writing instrument to illuminate an object, paper, and/or marking. Thereby, both the magnifier lens 19 and the object, paper and/or marking may also be illuminated while in use.

FIG. 3 illustrates the cover portion 35 of the top portion 3 in the close position 39. As can be seen, the cover portion 35 may extend away from the interior cavity 41 of the top portion and may cover the magnifier lens 19 and the second lighting source 29. With the rotation of the rotation knob 43 on the top edge 47 of the top portion 3 of the writing instrument 1, the cover portion 35 may be adjusted to open and extend to a position within the interior cavity 41. FIG. 3 also illustrates the threaded portion 51 of the top portion 3 which is received by the corresponding threaded portion 53 of the bottom portion 5. Additionally, as illustrated in FIG. 3, the writing instrument 1 may have a clip 71 extending away from the top edge 47 of the top portion 3 of the writing instrument whereby the clip 71 may be utilized by a user to attach the writing instrument 1 in traditional fashion to clothing, a pocket of an individual or another desired surface by the user. The clip 71 may be positioned directly beneath the rotation knob 43 such that the clip 71 does not interfere with the rotation knob 43 when a user desires to open and/or close the cover portion 35 relative to the magnifier lens 19.

FIG. 4 illustrates the bottom portion 5 of the writing instrument 1. As illustrated, the bottom portion 5 may have a cap 15 which may have a threadable portion 59 thereon which is adaptable to a corresponding threadable portion 61 on the bottom edge 63 of the bottom portion 5. The cap 15 may be removed from the bottom portion 5 of the writing instrument 1 to access the interior 13 of the writing instrument 1 and further wherein the cap 15 is removed to access the insert 9 which may be removed via the removal of the cap 15 from the bottom portion 5 wherein the ink 11 of the writing instrument 1.

Thus, specific embodiments and applications of the release agent of the present invention have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. An apparatus for use in marking of an object, the apparatus comprising:
a structure to accommodate a writing portion;
a magnifying portion incorporated into the structure;
an illumination portion incorporated into the structure; and
a power source in conjunction with the illumination portion whereby the power source provides power to initiate lighting.

2. The apparatus described in claim 1 wherein said power source is a battery.

3. The apparatus described in claim 1 wherein said magnifying portion is incorporated into the structure of the apparatus at the top portion of the writing apparatus.

4. The apparatus described in claim 1 wherein said magnifying portion is incorporated into the structure of the apparatus at the opposing end of the writing portion of the apparatus.

5. The apparatus described in claim 1 wherein said illumination portion is comprised of a LED bulb.

6. The apparatus described in claim 1 wherein said illumination portion is comprised of a plurality of lighting sources wherein the lighting source is an LED bulb.

7. The apparatus described in claim 1 wherein the apparatus structure comprises: a pen, pencil, marker, crayon, highlighter, and other writing instruments.

8. The apparatus described in claim 1 wherein the illumination portion and the magnifying portion of the apparatus are removably attached to the structure of the apparatus for removal and attachment thereto.

9. The apparatus described in claim 1 wherein the illumination portion has at least one light source directed away from the apparatus and at least one light source directed into the magnifier lens of the apparatus.

10. The apparatus described in claim 1 wherein the apparatus has a magnifier lens cover incorporated into an interior cavity of the apparatus.

11. The apparatus described in claim 1 wherein the apparatus has a rotation knob on a top portion of the apparatus whereby the rotation knob is utilized to close a cover over a magnifier lens.

12. The apparatus described in claim 1 wherein the apparatus has a clip extending away from the apparatus for attachment to an object.

13. A method for utilizing a writing instrument with a magnifier lens, the method comprising the steps of:
providing a structure to accommodate a writing portion;
providing a magnifying portion incorporated into the structure; and
providing an illumination source.

14. The method of claim 13 further comprising the step of:
providing a plurality of illumination sources.

15. The method of claim 13 further comprising:
providing a cover portion whereby the cover portion may be rotated to cover the magnifying portion and the illumination source.

16. The method of claim 13 further comprising the step of:
accessing a cover portion by utilizing a rotation knob contained on the top portion of the writing instrument.

17. The method of claim 13 further comprising the step of:
allowing an individual to utilize the writing instrument to mark an object.

18. The method of claim 13 further comprising the step of:
allowing an individual to utilize the writing instrument to mark an object whereby the lighting source may be turned on to illuminate the object prior to the individual making the marking.

19. The method of claim 13 further comprising the step of:
providing a cap portion to access the interior portion of the writing instrument to access an insert whereby the insert is an ink cartridge.

20. The method of claim 13 further comprising the step of:
providing a cover portion whereby the cover portion is rotatably move into a position over the magnifying portion and the lighting source whereby the user may rotatably open and close the cover portion relative to the magnifying portion and the lighting source.
